(19) United States
(12) Patent Application Publication
(10) Pub. No.: US 2026/0133847 A1
(43) Pub. Date: May 14, 2026

(54) AUTOSCALING ORCHESTRATION FOR MICROSERVICES

(71) Applicant: SAP SE, Walldorf (DE)

(72) Inventor: Hui LI, Shanghai (CN)

(21) Appl. No.: 18/947,403

(22) Filed: Nov. 14, 2024

(51) Int. Cl. G06F 9/50

(52) U.S. Cl. CPC G06F 9/5077; G06F 9/5022; G06F 9/505; G06F 2209/5019; G06F 2209/5022

(57) ABSTRACT

Systems and methods include creation of a first plurality of pods and a second plurality of pods in a volatile memory of a node, placement of each of the second plurality of pods in the volatile memory into an inactive state, execution of workloads using a service executing in containers of the first plurality of pods while the second plurality of pods in the volatile memory are in the inactive state, determining to add pods to the service and, in response to the determination to add pods to the service, changing of the state of a first one of the second plurality of pods to an active state and execution of workloads using the service executing in containers of the first plurality of active pods and in the first one of the second plurality of pods.

### BACKGROUND

A microservice-based application is implemented using independently-deployed microservices, each of which provides distinct functions of the application. Each microservice executes in its own computing process in a separate computing system (e.g., server/virtual machine/container) and is independently accessible. Advantageously, each microservice of a microservice-based application may be modified and redeployed without redeploying the entire application.

Microservices are often implemented in the cloud in order to leverage the redundancy, economies of scale and other benefits provided by cloud platforms. One such benefit is resource elasticity, which allows the computing resources (e.g., CPU power, memory size, and network bandwidth) consumed by a microservice to be efficiently scaled up and scaled down according to the needs of the microservice. For example, as CPU usage, memory usage, and/or RPS (incoming requests per second) of a microservice increase beyond a threshold, additional resources may be allocated to the microservice. Similarly, and in order to reduce operating costs, resources may be deallocated from the microservice if CPU usage, memory usage, and/or RPS decrease below a given threshold.

Microservices are often deployed in containers executed within pods of a container orchestration platform. To increase resources allocated to a container-deployed microservice, the orchestration platform may add pods for executing additional instances of the microservice. To decrease allocated resources, existing pods may be terminated.

The addition of a pod includes several steps, such as creation, container setup, initialization and startup. These steps introduce a time lag. During the time lag, the application may be in an unstable state, processing may be slow, and errors may occur.

Systems are desired for efficient scaling of microservices within a container orchestration platform.

### BRIEF DESCRIPTION OF THE DRAWINGS

FIG. 1 illustrates a system for orchestrating resource scaling using active pods and inactive pods according to some embodiments.

FIG. 2 illustrates a microservice cluster according to some embodiments.

FIG. 3 is a flow diagram of a process for orchestrating resource scaling in a microservice-based system according to some embodiments.

FIG. 4 illustrates adding active pods to a microservice according to some embodiments.

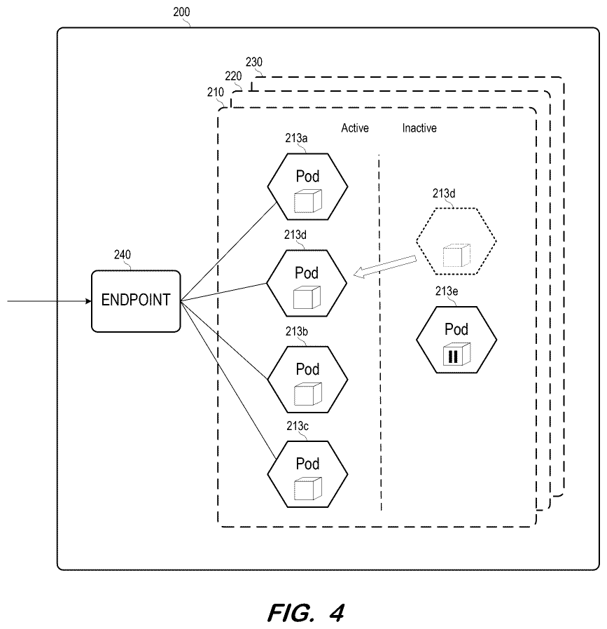

FIG. 5 illustrates adding inactive pods to a microservice according to some embodiments.

FIG. 6 illustrates removing active pods from a microservice according to some embodiments.

FIG. 7 illustrates a cloud-based cluster executing a microservice according to some embodiments.

### DETAILED DESCRIPTION

The following description is provided to enable any person in the art to make and use the described embodiments. Various modifications, however, will remain readily-apparent to those in the art.

Some embodiments facilitate resource scaling in a microservices-based system. Briefly, some embodiments provide inactive pods which reside in volatile memory (e.g., random-access memory) in an inactive state and which may be quickly activated when needed to process an incoming workload (e.g., service requests). The inactive state may be a state (e.g., hibernate) which occurs after instantiation and startup but which uses fewer computing resources than an active (i.e., workload-processing) pod. Embodiments may operate to ensure the ongoing availability of at least a threshold number of inactive pods.

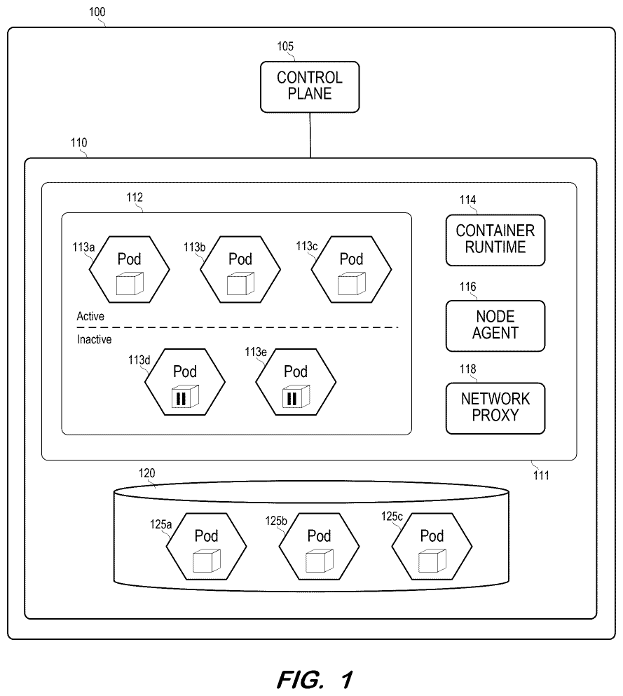

FIG. 1 illustrates a system according to some embodiments. The illustrated components of FIG. 1 may be implemented using any suitable combinations of computing hardware and/or software that are or become known. The FIG. 1 system may comprise any number of hardware and software components which provide functionality to one or more users (not shown). Such combinations may include on-premise servers, cloud-based servers, and/or elastically-allocated virtual machines. In some embodiments, two or more components are implemented by a single computing device.

Cluster 100 is a cluster of a container orchestration platform such as but not limited to Kubernetes. According to some embodiments, cluster 100 exposes computing functionality to users. The computing functionality may be referred to as an application, a service, a microservice, etc. For example, a microservice endpoint (not shown) receives a request from a user and cluster 100 executes program code of the microservice to fulfill the request.

Cluster 100 includes control plane 105 consisting of one or more master nodes and one or more worker nodes such as worker node 110. Cluster 100 may include any number of nodes, each of which may be a virtual machine or a physical machine. Node 110 includes pods 112 executing within memory 111 (e.g., random-access memory). As will be described below, pods 113a, 113b and 113c are Active pods and pods 113d and 113e are Inactive pods.

Each of pods 112 models an application-specific “logical host” and contains one or more containers and shared resources for its containers. The shared resources may include portions of storage 120, an IP address for its containers and runtime information such as container image versions and assigned network ports. The containers of a given pod 112 are co-located, co-scheduled, and run in a shared context of node 110.

A container is a process with enforced restrictions. Example of restrictions which may be enforced on a process include a maximum CPU utilization and a maximum memory utilization. A container executes a container image, also referred to as a containerized application. A container image is a self-contained executable package containing an executable (i.e., an application) and a runtime required by the executable, if any, dependencies (e.g., application and system libraries), and default values of configuration settings.

For purposes of the present example, it will be assumed that each of pods 112 includes one container. The container of each pod 112 executes the same container image. Accordingly, a workload request received by cluster 100 from a user may be served by any of Active pods 113a, 113b and 113c.

Memory 111 also includes executing processes such as container runtime 114, node agent 116 and network proxy 118. Container runtime 114 is responsible for creating new containers, retrieving corresponding container images, setting up a resource-restricted process space and a file system for the containers, and starting, stopping and deleting the containers. Node agent 116 registers node 110 with control plane 105 and ensures that node 110 includes running containers which conform to pod specifications associated with node 110. Network proxy 118 maintains network rules on node 110 to allow network communication between pods 112 and network sessions inside or outside of cluster 100.

Control plane 105 manages cluster 100 based on a manifest file. A manifest file describes a desired state of a microservice to be provided by a cluster. Based on the manifest file, components of control plane 105 deploy corresponding nodes, pods and containers within cluster 100 to implement the desired state.

Control plane 105 also monitors and manages the elements of cluster 100 to ensure the current state conforms to the desired state. Control plane 105 may adjust the number of pods in a given worker node, the number of worker nodes and/or the computing resources of a worker node based on differences between a current state and the desired state. For example, in response to detecting the failure of a node including a certain number of pods, control plane 105 may identify available nodes in the cluster and schedule the same number of identical pods on those nodes.

Some embodiments provide horizontally scaling of the number of pods on a node based on resource utilization metrics. The metrics may be determined by a metrics server (not shown) of the cluster which communicates with the node agents of each node. Horizontal scaling may include modifying the pod specification of a node to increase or reduce the number of pods and providing the new pod specification to the node.

For example, control plane 105 may determine that pods 113a, 113b and 113c are operating (and/or will soon be operating) near a resource utilization upper limit. In response, control plane 105 modifies the pod specification of node 110 to increase the number of pods of node 110. Node agent 116 then acts based on the new pod specification to add one or more Active pods to pods 112. As will be described below, adding an Active pod may include changing one or both of pods 113d and 113e from an Inactive state to an Active state. Changing the state of a pod according to some embodiments will be described in detail below.

Conversely, control plane 105 may determine that one of pods 113a, 113b and 113c is operating (and/or will soon be operating) near a resource utilization lower limit. Control plane 105 may therefore modify the pod specification of node 110 to decrease the number of pods of node 110. In response, node agent 116 removes one or more Active pods from pods 112. Removal may comprise terminating and deleting an Active pod, or changing the state of an Active pod from Active to Inactive.

Storage 120 may comprise any number of standalone or distributed data storage systems. Storage 120 may be used by pods 112 as described above. Storage 120 also stores pods 125a, 125b and 125c. Each of pods 125a, 125b and 125c is a serialized copy of a pod, including a container image for each container of the pod and metadata describing the shared resources of the pod. According to some embodiments, node agent 116 may create a new Inactive pod within pods 112 by deserializing and executing one of pods 125a, 125b and 125c, and placing the pod in an Inactive state as will be described below.

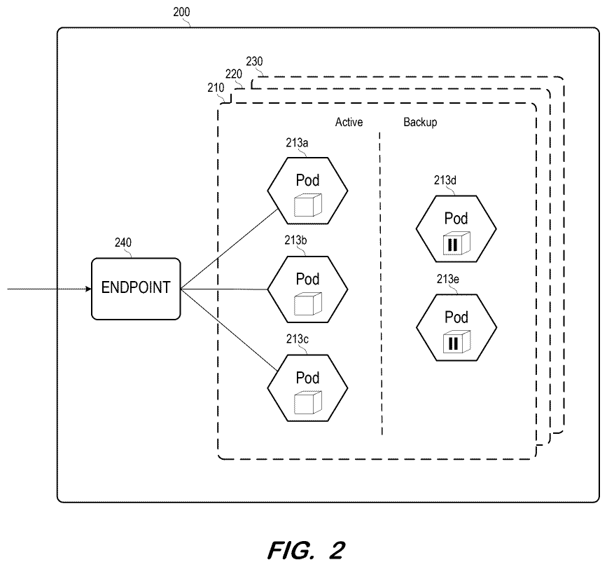

FIG. 2 illustrates cluster 200 according to some embodiments. Cluster 200 may provide a scalable microservice to users. Cluster 200 includes nodes 210, 220 and 230, each of which may operate as described with respect to node 110 of FIG. 1. For example, each of nodes 210, 220 and 230 may include one or more Active pods and one or more Inactive pods executing in memory.

Cluster 200 receives incoming requests from external clients. For example, a gateway receives a request (e.g., an Application Programming Interface (API) call via Hyper Text Transfer Protocol (HTTP)) associated with a microservice-based application from a client device. The gateway determines that the request should be forwarded to a microservice provided by cluster 200 and forwards the request to endpoint 240 of cluster 200.

Each Active pod of nodes 210, 220 and 230 includes a container executing the microservice of cluster 200. Endpoint 240 forwards the request to one of the Active pods. Endpoint 240 may determine the pod to which the request is forwarded using any suitable algorithm (e.g., round-robin, load-balancing). Endpoint 240 does not forward the request to an Inactive pod of cluster 200, such as Inactive pods 213d and 213c.

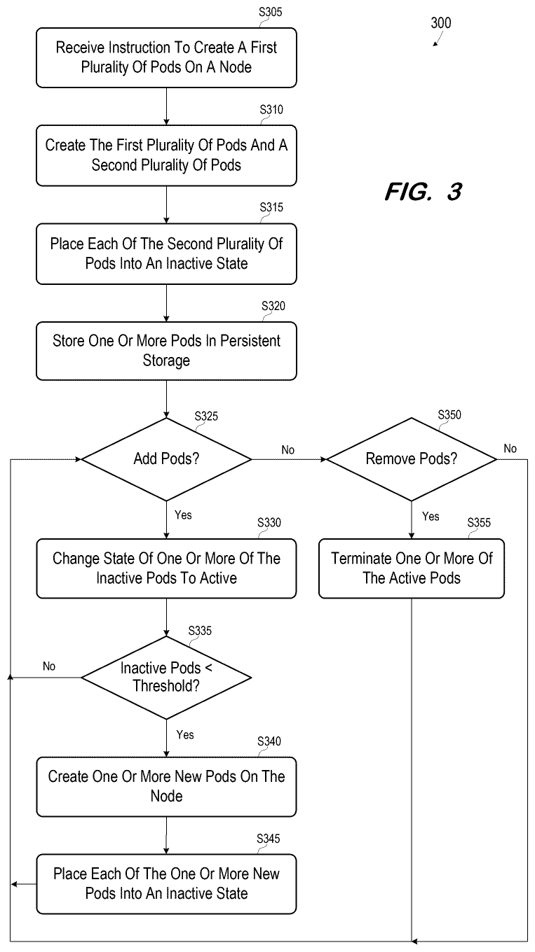

FIG. 3 is a flow diagram of process 300 for orchestrating resource scaling in a microservice-based system according to some embodiments. Process 300 and the other processes described herein may be performed using any suitable combination of hardware and software. Program code embodying these processes may be stored by any non-transitory tangible medium, including a fixed disk, a volatile or non-volatile random-access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

Initially, at S305, an instruction to create a first plurality of pods on a node is received. The instruction may be received by a node agent such as node agent 116 of FIG. 1. According to some embodiments, the instruction is issued by a cluster control plan such as control plane 105. For example, an administrator may issue an instruction to a controller of control plane 105 to create a pod including a container with a specified container image using a command line, e.g., kubectl run<name of pod>--image=<name of image>. A pod may also be created in a declarative manner, e.g., kubectl create-f pod.yaml, where pod.yaml is the following manifest:

```
apiVersion: apps/v1
  kind: Pod
  metadata:
    name: <name of pod>
  spec:
    containers:
      - name: <name of the container>
        image: <name of the container image>
        ports:
          - containerPort: <port number>
```

In yet another example, a set of identical pods (i.e., a replica set) may be created using the command kubectl apply-f deployment.yaml, where deployment.yaml is the following manifest:

```
apiVersion: apps/v1
kind: Deployment
metadata:
  name: <deployment name>
  labels:
    app: <microservice name>
spec:
  replicas: <number of replica pods>
  selector:
    matchLabels:
      app: <microservice name>
  template:
    metadata:
      labels:
        app: <microservice name>
    spec:
      containers:
      - name: <name of container>
        image: <name of container image>
        ports:
        - containerPort: <port number>
```

Upon receiving an instruction to create the one or more pods, the controller asks a scheduler of the control plane to schedule the pods on one or more nodes. The scheduler may use various algorithms and heuristics to determine a node on which to schedule each pod. For purposes of the present example, it will be assumed that the scheduler determines to schedule a first plurality of pods on a node, i.e., to bind the pods to the node. Accordingly, the control plane transmits an instruction to a node agent of the node to create the first plurality of pods and the instruction is received at S305.

In response to the instruction, the first plurality of pods are created on the node at S310 as is known in the art. For example, node agent 116 creates containers for the pods using container runtime 118. Creating the containers includes downloading the container image to be executed by the containers. The container of each pod is then executed to place the pod in a running, or Active, state. In the Active state, a pod is able to receive and serve workloads such as requests to the microservice being executed by its container. Generally, a process in an Active state is allocated CPU time slices, enabling the process to execute program code and instructions. A process in the Active state also consumes memory to store its program code, data, stack, heap, and other runtime resources.

A second plurality of pods are also created at S310. The second plurality of pods are created in the same manner and using the same pod specification (container image, etc.) as the above-mentioned first plurality of pods. The number of the second plurality of pods may be configured as a fixed number (e.g., 3), as a function of the number of the first plurality of pods (e.g., half the number), a function of the expected workload of the node, etc.

Each of the second plurality of pods is placed in an Inactive state at S315. The Inactive state is a state which limits the resources (e.g., memory, CPU cycles) consumed by a pod in comparison to the resources consumed by pods in the Active, or running, state. Embodiments may employ any type of suitable Inactive pod state. For example, some embodiments may place the container process of each of the second plurality of pods into hibernation. A container process in hibernation does not execute any instructions and therefore does not require any CPU time slices. The container process may still occupy some memory to preserve its context and state.

According to some embodiments, each of the second plurality of pods is placed in an inactive state at S315 by pausing its containers. In this regard, a container runtime may provide a pause command to pause selected containers on a node. The pause command places the container in a waiting state in which the container does not execute any instructions.

One or more pods are stored in persistent storage of the node at S320. S320 may comprise serializing one of the second plurality of Inactive pods into a file and storing the file in persistent storage of the node. The serialized file may comprise the container image and the context of the Inactive pod, but embodiments are not limited thereto. A pod may be created as an Inactive pod within the volatile memory by deserializing the stored file, and such creation may be faster than the conventional creation of a pod as described above.

At S325, it is assumed that the containers of the Active pods of the node are executing the microservice of the node to serve incoming workloads, while the Inactive pods remain inactive. During this execution, it is determined at S325 whether or to add Active pods to the node. If the determination is negative, flow proceeds to S350 to determine whether to remove any active pods from the node. Flow returns to S325 if the determination at S350 is negative. Accordingly, flow cycles between S325 and S350 which the Active pods are executing until it is determined at S325 to add one or more Active pods to the node or it is determined at S350 to remove one or more Active pods from the node.

At some point of execution, it may be determined at S325 to add pods to the node. The determination may be based on any factors known in the art, such as but not limited to detection of a pod failure, detection of high resource usage of one or more of the existing Active pods, and expectation of future high resource usage of one or more of the existing Active pods. In the case of pod failure, a node agent may detect the pod failure and determine to add a pod in order to conform the node to its current pod specification. In the latter cases, the control plane may detect the high resource usage (or expectation thereof) and update the pod specification of the node to add one or more pods thereto, causing the node agent to determine to add the one or more pods. The latter cases are examples of horizontal autoscaling as is known in the art.

Flow proceeds to S330 if it is determined to add pods to the node at S325. At S330, the state of one or more of the Inactive pods in the node's volatile memory is changed to Active. If the one or more Inactive pods are in a hibernation state, changing the state to Active may include moving the container processes of the nodes from the hibernation queue to the ready queue so the processes are eligible for CPU scheduling and allocating resources such as files and network services that were released when the pod entered hibernation at S315. If the one or more Inactive pods include a paused container, the container may be un-paused at S330 to change the state of the pods to Active. The now-Active pods may, along with the previously-Active pods, begin to independently service workloads to the microservice of the cluster.

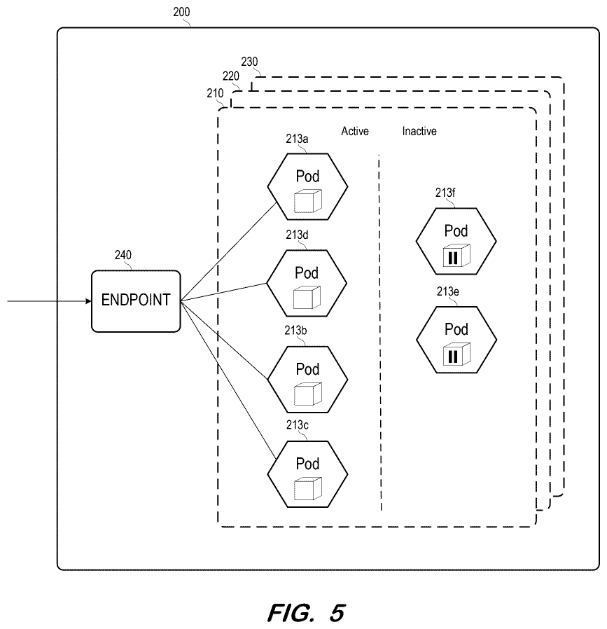

FIG. 5 illustrates changing the state of an Inactive pod according to some embodiments of S330. Inactive pod 213d remains in the volatile memory of node 210 but is now running to receive workloads from endpoint 240 in parallel with Active pods 213a, 213b and 213c. Pod 213e remains Inactive and is the sole Inactive pod of node 210.

Next, at S335, it is determined whether the number of Inactive pods is less than a threshold number. The threshold number reflects a minimum number of Inactive pods desired for the node. An Inactive pod consumes some resources so the threshold number may be as small as needed to suitably react to workload spikes which may be experienced by the node. The threshold number may be configured as described above with respect to the number of the second plurality of pods created at S310. The threshold number may differ from the number of the created second plurality of pods and also may differ at different iterations of S335.

Flow returns to S325 if it is determined at S335 that the number of Inactive pods is not less than the threshold. If the number of Inactive pods is less than the threshold, one or more new pods are created on the node at S340. The new pods may be created as described with respect to S310. However, in some embodiments, the new pods may be created based on the pod files stored at S320. As described above, deserialization of a locally-stored pod file into a memory of a node may result in faster creation of the pod than conventional systems.

Each of the new pods is placed into an Inactive state at S345, which may proceed as described with respect to S315. Accordingly, the number of new pods created at S340 may be determined such that the total number of Inactive pods after conclusion of S345 will be greater than the threshold of S335.

FIG. 5 illustrates the addition of Inactive pod 213f to node 210 according to some embodiments at S340 and S345. Inactive pod 213f exists in the memory of node 210 along with pods 213a-213e, with pods 213a-213d being Active and pod 213e being Inactive. Embodiments are not limited to creating the same number of nodes at S340 as were changed from Inactive to Active at S330.

Flow returns from S345 to cycle between S325 and S350. During this period, the Active pods of the node continue processing incoming workloads in parallel. It may be determined at S350 to remove an Active pod from the node. The determination may be based on errors detected with respect to the Active pod, low resource usage of one or more of the Active pods, and/or an expectation of future low resource usage of one or more of the Active pods. The determination at S350 may be made by a node agent independently or based on a communication received from the control plane.

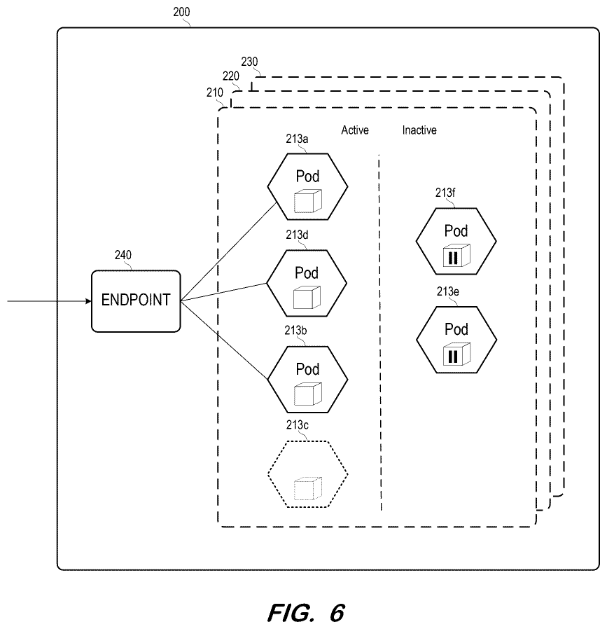

If it is determined to remove a pod, one or more of the Active pods are terminated at S355. Termination of a pod may include terminating the container of the pod and deletion of the pod from memory. FIG. 6 illustrates termination of Active pod 213c at S355 according to some embodiments. Flow returns from S355 to S325 after termination of the one or more Active pods. Process 300 then may continue in the above-described manner to add and remove Active pods as needed.

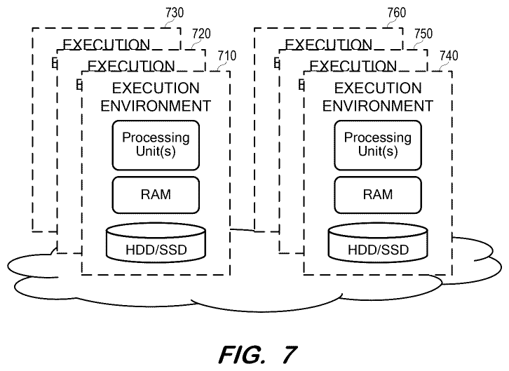

FIG. 7 illustrates a cloud-based deployment according to some embodiments. The illustrated components may comprise cloud-based compute resources residing in one or more public clouds providing self-service and immediate provisioning, autoscaling, security, compliance and identity management features.

Execution environments 710-760 may comprise servers or virtual machines of a Kubernetes cluster. Execution environments 710-760 may support pods for executing containerized applications which provide one or more services to users. Execution environments 710-730 may comprise a control plane of a cluster while execution environments 740-760 may comprise worker nodes of the cluster. Each worker node may operate as described herein to add Active pods from in-memory Inactive pods and to create in-memory Inactive pods based on locally-stored serialized pod files.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of networks and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a hard disk, a DVD-ROM, a Flash drive, magnetic tape, and solid-state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a persistent storage system;
a volatile memory storing executable program code; and
one or more processing units to execute the executable program code to cause the system to:
create a first plurality of pods and a second plurality of pods in the volatile memory;
place each of the second plurality of pods in the volatile memory into an inactive state;
store one or more pods in the persistent storage system;
execute workloads using a service executing in containers of the first plurality of pods while the second plurality of pods in the volatile memory are in the inactive state;
determine to add pods to the service; and
in response to the determination to add pods to the service:
change the state of a first one of the second plurality of pods to an active state; and
execute workloads using the service executing in containers of the first plurality of active pods and in the first one of the second plurality of pods.

2. The system according to claim 1, wherein the determination to add pods to the service is based on an expected future workload of the service.

3. The system according to claim 1, the one or more processing units to execute the executable program code to cause the system to:
determine that a number of pods in the volatile memory in the inactive state is less than a threshold; and
in response to the determination that the number of pods in the volatile memory in the inactive state is less than the threshold:
create one or more pods in the volatile memory;
place each of the one or more pods in the volatile memory into an inactive state.

4. The system according to claim 3, the one or more processing units to execute the executable program code to cause the system to:
determine to remove a pod from the service; and
in response to the determination to remove a pod from the service, terminate one of the first plurality of pods.

5. The system according to claim 4, wherein the determination to add a pod to the service is based on a first expected future workload of the service, and
wherein the determination to remove a pod from the service is based on a second expected future workload of the service.

6. The system according to claim 1, the one or more processing units to execute the executable program code to cause the system to:
determine to remove a pod from the service; and
in response to the determination to remove a pod from the service, terminate one of the first plurality of pods.

7. The system according to claim 6, wherein the determination to remove a pod from the service is based on a second expected future workload of the service.

8. The system according to claim 1, wherein the placing of each of the second plurality of pods in the volatile memory into an inactive state comprises pausing of a container of each of the second plurality of pods, and
wherein changing of the state of the first one of the second plurality of pods comprises un-pausing the container of the first one of the second plurality of pods.

9. The system according to claim 1, wherein placing of each of the second plurality of pods in the volatile memory into an inactive state comprises placing a container of each of the second plurality of pods into hibernation.

10. A method comprising:
creating a first plurality of pods and a second plurality of pods in a volatile memory of a node;
placing each of the second plurality of pods in the volatile memory into an inactive state;
executing workloads using a service executing in containers of the first plurality of pods while the second plurality of pods in the volatile memory are in the inactive state;
determining to add pods to the service; and
in response to the determination to add pods to the service:
changing the state of a first one of the second plurality of pods to an active state; and
executing workloads using the service executing in containers of the first plurality of active pods and in the first one of the second plurality of pods.

11. The method according to claim 10, wherein determining to add pods to the service is based on an expected future workload of the service.

12. The method according to claim 10, further comprising:
determining that a number of pods in the volatile memory in the inactive state is less than a threshold; and
in response to determining that the number of pods in the volatile memory in the inactive state is less than the threshold:
creating one or more pods in the volatile memory;
placing each of the one or more pods in the volatile memory into an inactive state.

13. The method according to claim 12, further comprising:
determining to remove a pod from the service; and
in response to determining to remove a pod from the service, terminating one of the first plurality of pods.

14. The method according to claim 13, wherein determining to add a pod to the service is based on a first expected future workload of the service, and
wherein determining to remove a pod from the service is based on a second expected future workload of the service.

15. The method according to claim 10, further comprising:
determining to remove a pod from the service; and
in response to determining to remove a pod from the service, terminating one of the first plurality of pods.

16. The method according to claim 15, wherein determining to remove a pod from the service is based on a second expected future workload of the service.

17. The method according to claim 10, wherein the placing each of the second plurality of pods in the volatile memory into an inactive state comprises pausing a container of each of the second plurality of pods, and
wherein changing the state of the first one of the second plurality of pods comprises un-pausing the container of the first one of the second plurality of pods.

18. The method according to claim 10, wherein placing each of the second plurality of pods in the volatile memory into an inactive state comprises placing a container of each of the second plurality of pods into hibernation.

19. One or more non-transitory computer-readable media storing program code executable by a computing system to cause the computing system to:
create a first plurality of pods and a second plurality of pods in the volatile memory;
place each of the second plurality of pods in the volatile memory into an inactive state;
execute workloads using a service executing in containers of the first plurality of pods while the second plurality of pods in the volatile memory are in the inactive state;
determine to add pods to the service; and
in response to the determination to add pods to the service:
change the state of a first one of the second plurality of pods to an active state; and
execute workloads using the service executing in containers of the first plurality of active pods and in the first one of the second plurality of pods.

20. The one or more non-transitory computer-readable media according to claim 19, the program code executable by a computing system to cause the computing system to:
determine that a number of pods in the volatile memory in the inactive state is less than a threshold; and
in response to the determination that the number of pods in the volatile memory in the inactive state is less than the threshold:
create one or more pods in the volatile memory;
place each of the one or more pods in the volatile memory into an inactive state.
